(19) United States
(12) Patent Application Publication
(10) Pub. No.: US 2014/0340051 A1
(43) Pub. Date: Nov. 20, 2014

(54) BATTERY CHARGE MANAGEMENT AND CONTROL

(71) Applicant: AMX LLC, Richardson, TX (US)

(72) Inventor: James Roger Hargrave, Wylie, TX (US)

(73) Assignee: AMX LLC, Richardson, TX (US)

(21) Appl. No.: 13/893,805

(22) Filed: May 14, 2013

(51) Int. Cl. H02J 7/00

(52) U.S. Cl. CPC H02J 7/007
USPC 320/162

(57) ABSTRACT

Disclosed are an apparatus and method of monitoring and charging a battery based on predefined criteria. One example method may include identifying an event entry stored in an event application, estimating a time duration associated with the event, calculating an amount of battery charge required to satisfy the event being conducted on an electronic device, and charging a battery of the electronic device to a charge level corresponding to the calculated amount of battery charge.

### TECHNICAL FIELD OF THE APPLICATION

This application relates to a method and apparatus of charging a battery, and more specifically, to determining a limit on the amount of battery charging to perform based on various battery use criteria.

### BACKGROUND OF THE APPLICATION

Conventionally, the batteries used to power a laptop, cell phone, tablet computing device, smartphone, etc., are charged by interfacing the device with a charging plug, cradle, etc. The amount of charge provided to a battery is inevitably a full charge over a period of charging time.

However, the physical composition of a lithium ion battery, a nickel cadium battery or other types of batteries used in everyday electronic devices may degrade rapidly if overcharged for extended periods of time. In other words, too much charge and not enough respective discharge (i.e., battery use) may lead to a loss of charge maintain capabilities for the battery. This result, in turn, leads to a battery that is not capable of holding charge, which can cause disruption and customer dissatisfaction as the battery begins to fail.

The cost of new batteries for the various user devices possessed by the everyday consumer can add up quickly. Also, certain devices, such as APPLE® products and newer smartphone devices generally do not offer battery replacement options as the batteries are sealed away from user access. Further, the amount of overcharging is beginning to have an impact on the power grid by wasting energy for charging a device that may not require such charge at any given moment in time.

### SUMMARY OF THE APPLICATION

One embodiment of the present application may include a method including identifying an event entry stored in an event application, estimating a time duration associated with the event, calculating an amount of battery charge required to satisfy the event being conducted on an electronic device, and charging a battery of the electronic device to a charge level corresponding to the calculated amount of battery charge.

Another example embodiment of the present application may include an apparatus that includes a processor configured to identify an event entry stored in an event application, estimate a time duration associated with the event, and calculate an amount of battery charge required to satisfy the event being conducted on an electronic device, and a battery charging interface configured to charge a battery of the electronic device to a charge level corresponding to the calculated amount of battery charge.

### BRIEF DESCRIPTION OF THE DRAWINGS

FIG. 1 illustrates an example battery charge level and corresponding battery usage configuration, according to example embodiments.

FIG. 2 illustrates an example battery charge management operation, according to example embodiments.

FIG. 3 illustrates an example flow diagram of battery charge management logic, according to example embodiments.

FIG. 4A illustrates an example schedule application and corresponding battery management procedure, according to example embodiments.

FIG. 4B illustrates a flow chart that provides an example method of operation.

FIG. 4C illustrates another flow chart that provides another example method of operation.

FIG. 5 illustrates an example battery charge control system, according to example embodiments.

FIG. 6 illustrates an example network entity device configured to store instructions, software, and corresponding hardware for executing the same, according to example embodiments.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments of the present application provide hardware and/or software that manages the amount of charge or the length of a charging operation applied to a battery. For example, a battery may be used in a handheld device, such as a cell phone, smartphone, tablet computing device, laptop or other hardware device. The battery may be lithium ion, nickel cadium or any battery type known to one skilled in the art. The amount and/or time for a charge to be applied to a battery at any given charging session may be increased or decreased depending on a number of factors discussed in detail below.

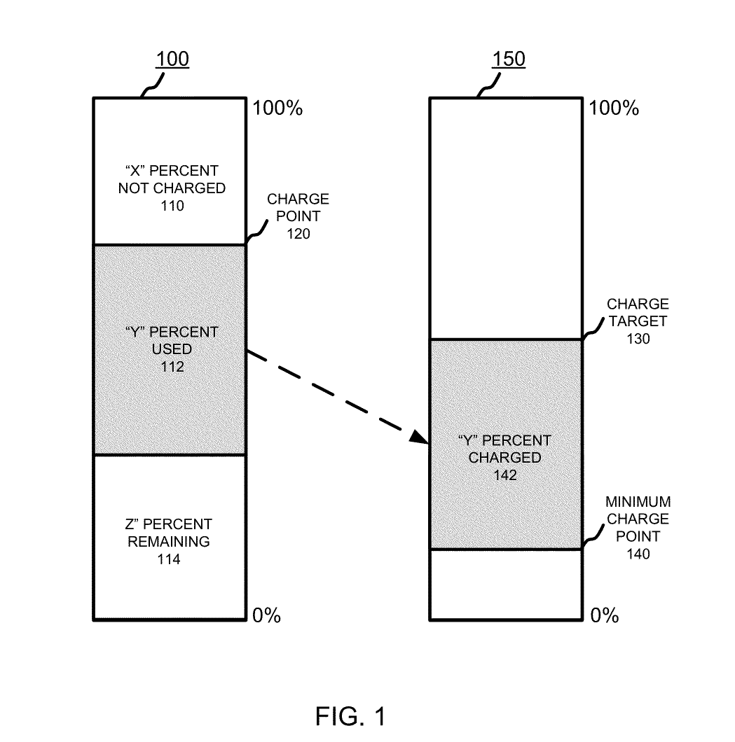

FIG. 1 illustrates an example battery charge level 100 and corresponding battery usage, according to example embodiments. Referring to FIG. 1, the battery charge may be anywhere between the range of zero and 100%. In this example, the charge point 120 is approximately 75% of the entire charge capacity of the battery. The variable “X” represents the amount of battery capacity that is not charged 110. The variable “Y” is the percent of the battery used 112 by a corresponding device as operated by a user, and the remaining percent 114 is represented by the variable “Z.” The “Y” percent may be a particular amount of usage attributed to a historical use pattern, such as a one hour phone call 3-5 times a week, a particular smartphone application used every day at noon for 30 minutes or more, a presentation performed every Monday morning at 10 am for 1-2 hours, etc.

Once a known use percentage “Y” has been tracked by a tracking application for one day, one week, one month, etc., the amount of battery consumption may become a known use variable that is applied to a charging operation for future battery charging efforts. For example, FIG. 1B illustrates an example battery charge level and corresponding battery usage based on historical battery use information, according to example embodiments. The battery usage 150 includes a mapping from a previously identified percent used 112 “Y” that is used as a basis for a new percent charged margin 142 of a total battery charge capacity. The targeted “Y” percent used 112 becomes the basis for the amount of charging to perform to the battery after it was detected during an initial training or identification procedure. A minimum charge point 140 may represent a buffer of a minimum amount of charge required at all times (i.e., 5%, 10%, 15%, etc.) that is measure from zero to the minimum charge point 140. The charge target 130 may be a function of a previously user amount of charge added to the minimum charge point. For example, the charge target=10% minimum charge+35% historical use charge=45% charge of the total battery capacity. Other percentages may be used to represent the variables used to arrive at the charge target 130. The amount of charge required may also be equated to a time frame for charging the battery to arrive at the charge target 130 (i.e., 20 minutes, 22 minutes, minutes, etc.) depending on the charger hardware and/or software and the battery's characteristics.

Regarding battery discharge, a normal discharge may occur any time the battery is being utilized by the corresponding device and the battery is not receiving a charge from an external charge source. A conditioning discharge may occur when a regular battery maintenance procedure is being performed to reduce a particular battery charge level. In operation, the conditioning discharge may initiate a software application or other device function to be performed to the device in order to draw current from the battery and reduce the charge level. For example, a high discharge function, such as a GPS antenna finding function or a WIFI signal seeking function may be initiated to rapidly draw current from the battery and reduce its overall charge level. Automatic and periodic checks may be performed to monitor battery charge levels to ensure the battery is not over discharged (e.g., 30 seconds, 60 seconds, etc.) during a conditional discharge operation.

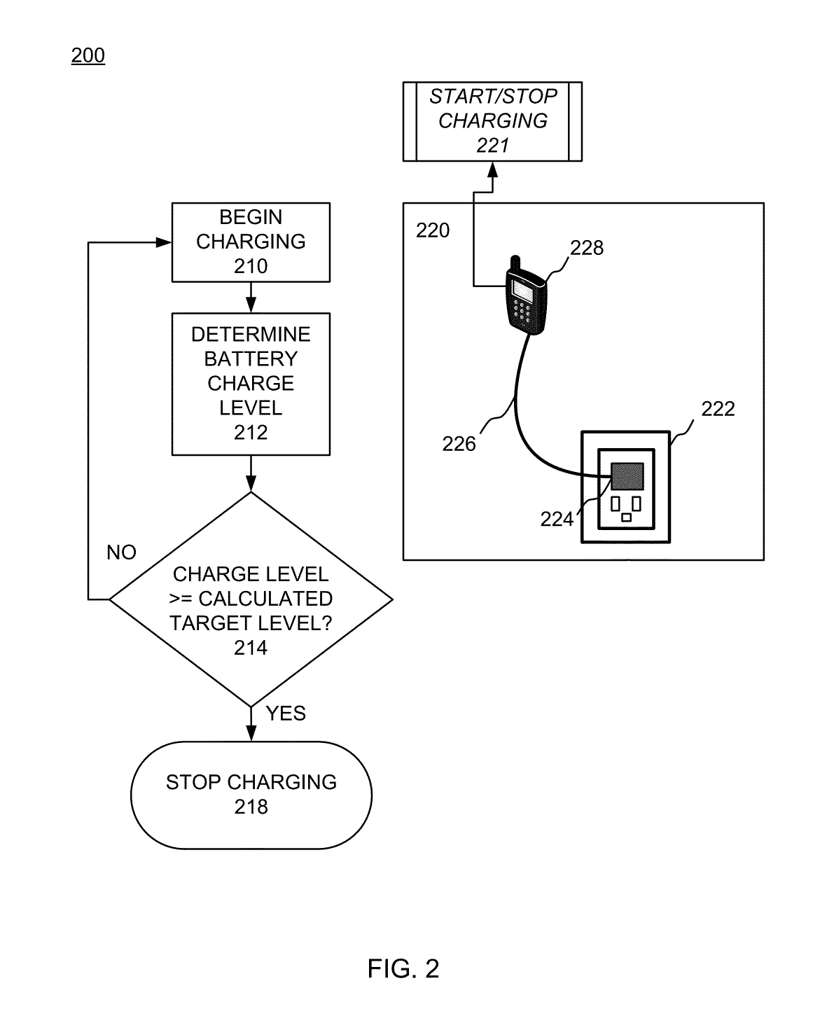

FIG. 2 illustrates an example battery charge management operation, according to example embodiments. Referring to FIG. 2, the charge configuration and procedure 200 may include a battery charge portion 220 with a battery driven device 228 (i.e., smartphone) and an AC power supply 224 with a cable and device interface 226. The AC power supply may be plugged into a power source 222. The AC power supply may have a switch that initiates charging or non-charging states in the power outlet box portion 224 or in the device interface of the device which is separate from the power outlet box portion 224 and the cable interface 226 (i.e., serial interface). For example, a software application may enable a trigger signal that enacts the charging to stop or start 221 via a measured amount of time that is controlled by a bit enabled logic interface of any of the above-noted hardware components.

In operation, the charger may begin charging the battery 210 the moment that the charge device 224 is plugged into the power supply 222 and the mobile device 228. The amount of battery charge level 212 is then determined and compared to a target level of battery charge based on known usage history or other usage variables (e.g., current usage, estimated usage, time of day, battery capacity, user profile, etc.). The charge level of the battery is then determined to be greater or equal to a threshold, such as the calculated target charge level. If the battery charge level is lower than the desired target threshold level, then the charging is continued by returning to operation 210. If the battery charge level is greater or equal to the target level then the charging is stopped at operation 218. A signal may be transmitted to the charge interface in the device 228 or the charge unit 224 to disable/enable the battery charging 221 based on the logic operations described in detail above. The bitwise logic may be configured to operate on a serial cable interface or bidirectional digital interface. In operation, the panel may transmit a signal every so many seconds (e.g., 15, 30, 45, 60, 90, etc.) to prompt the power charging source, such as the charging cradle, to power-off. If a predetermined amount of time passes without a message being received, then the charging source (i.e., cradle) will then turn its charging capabilities back to the ‘on’ position and initiate a battery charging operation.

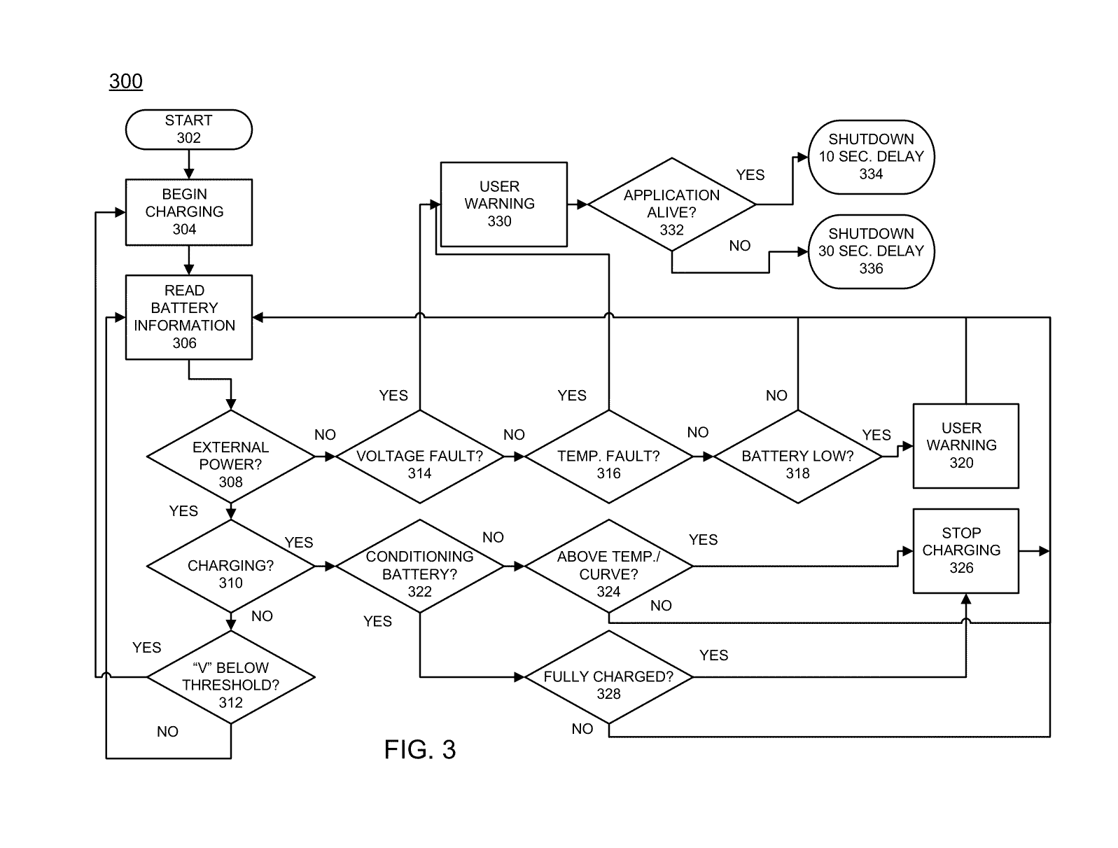

FIG. 3 illustrates an example flow diagram of battery charge management logic, according to example embodiments. Referring to FIG. 3, the flow diagram 300 includes an initial start operation 302 and a begin charging operation 304. The battery information is identified at operation 306 to determine if external power is being provided at operation 308, and if so, the charging will be performed at operation 310, and the voltage is then determined to be below/above a recharge threshold at operation 312. If the voltage is below the target threshold then the battery will begin charging at operation 304. If the voltage is not below the target threshold then the battery information is again 306 identified for additional processing.

Continuing with FIG. 3, if the external power is not detected 308, then a determination is made as to whether there is a voltage fault 314, a temperature fault 316 and/or whether the battery is low 318. If so, the user is warned via a message 320/330 on his or her smartphone device interface. If an application is currently alive 332 on the device, then a 10 second delay 334 is enacted before shutdown is performed, if not, then a 30 second delay 336 is performed prior to performing a shut down operation.

In the charging decision 310 of FIG. 3, if the battery is charging then a determination is made as to whether the battery is conditioned 323, if not, then a determination is made as to whether the temperature of the battery is above a particular level or curve 324, if so, then the charging may be stopped 326, if not then charging may be continued. Next, a decision is made as to whether the battery is fully charged 328 assuming the battery is being conditioned. If the battery is fully charged 328, the application stops the charging operation and if not then the charging is continued and the battery information is read again to determine then next charging management operation.

When identifying information about a particular battery or initiating feedback about the battery's charge, such information may be identified from a 64-register processing chip. The calculations may be derived from one or more of voltage levels, cell voltage, current, temperature, and remaining capacity levels. In operation, the application may begin with no awareness of the battery. An initial operation may include detecting the presence of the battery by a positive voltage detection or current detection from the battery's response to an active signal sent via the charging interface. The applied charge may initiate a connection or response with the battery. If the battery is being used to operate the corresponding device (e.g., smartphone), then the battery may be protected from damage by initiating a shutdown procedure if the temperature is out of an acceptable range, or if the voltage or capacity is too low. If the device is receiving charge from an external source then the battery may be charged if its current charge level is below a target charge threshold. Also, while charging the battery, it may be necessary to require protection from high temperatures 336.

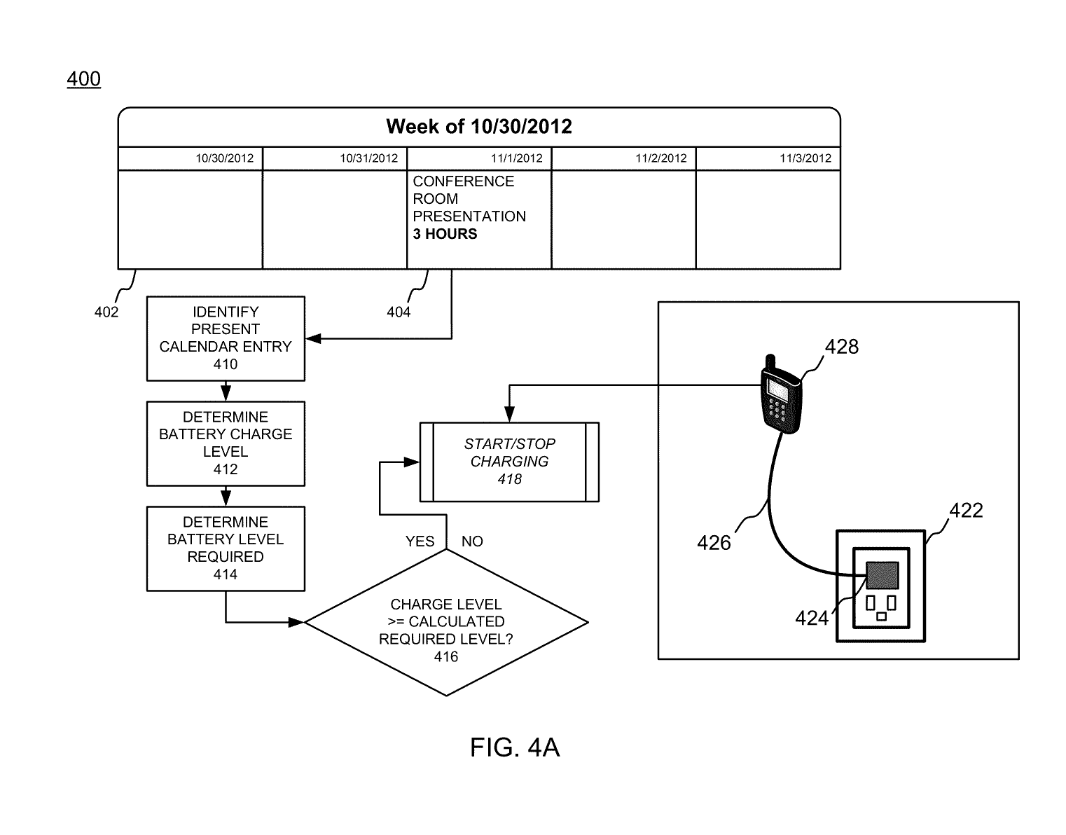

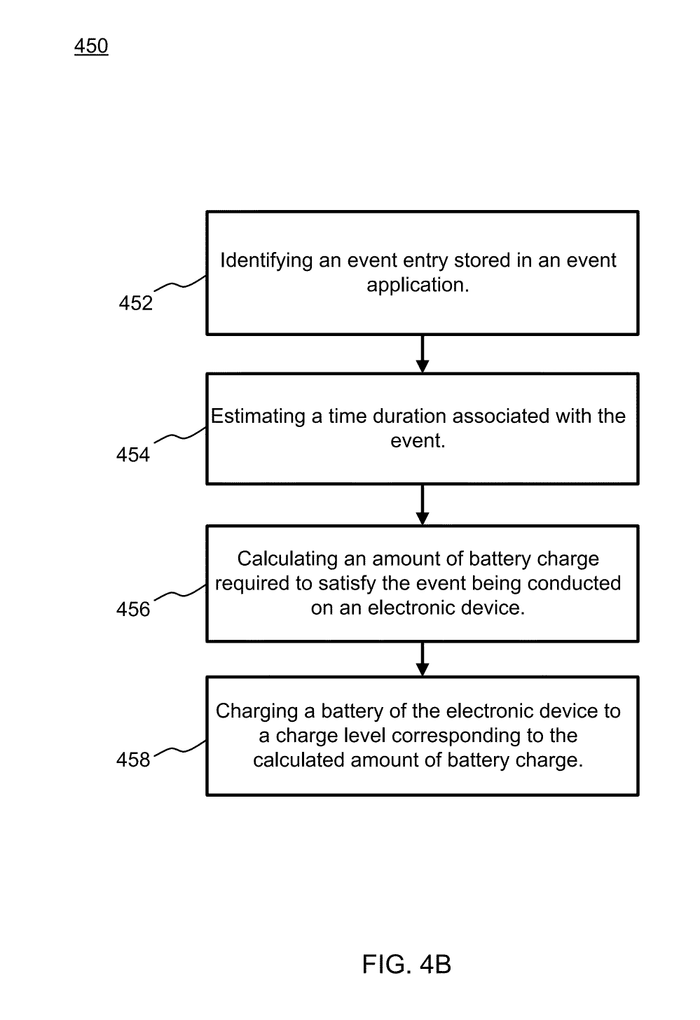

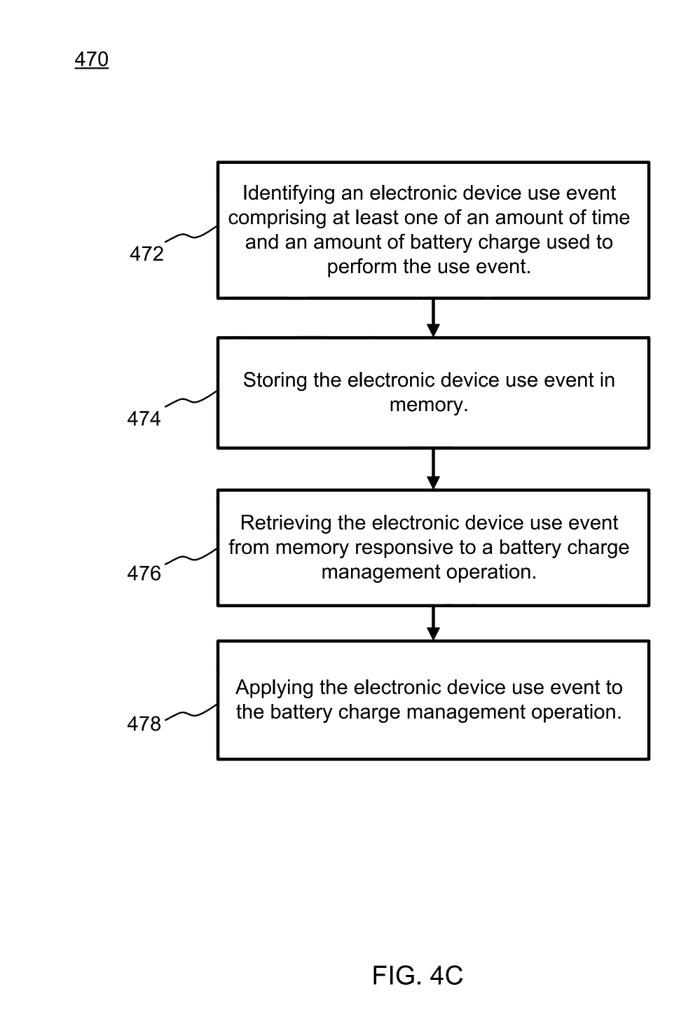

FIG. 4A illustrates an example schedule application and corresponding battery management procedure, according to example embodiments. Referring to FIG. 4A, the application battery charge management example 400 is a calendar application 402 that includes a particular entry 404 for a conference room presentation with a corresponding time duration. According to one example, the mobile device or smartphone 428 may be plugged into a charging device 424 via a plug interface 426. The charging device 424 may be plugged into a power source 422 that is configured to provide power at any time.

The battery charge management application may be operating in the background of the smartphone's operating system. The application may identify a particular event “3 hour presentation” and identify the amount of power required based on the time of the scheduled event, the type of event (e.g., Internet service required, GPS signal required, applications required, etc.) and determine an estimate as to the amount of battery charge required to maintain the battery level for the entire event without overcharging and wasting energy and battery life and/or without undercharging so the device quits due to a lack of battery charge during the event.

One example procedure for identifying a calendar event and incorporating the event into a battery charge operation may provide identifying a present calendar entry 410 by considering the present day, the present time slot or the 1-4 hours in the near future. Those identified events are then compared to a battery charge level 412 of the present battery charge status. The difference between the battery level required and the current battery level is then calculated 416 and if the value is negative no charge is required. However, if the difference value is positive and the current battery level is less than what is required, then the difference value is applied to a battery charge function used to determine how much time and/or how much charge is required 414 to prepare the battery for the present calendar entry or event.

The battery charger is then controlled via a battery charge application which transmits an enable or disable signal to the charge interface (i.e., serial interface, USB interface) depending on whether more charge is required for the upcoming calendar event. The charge initiation or stopping 418 may be performed to charge the battery of the user's device just enough to reduce the amount of power usage and to ensure the battery's total charge capacity is at a nominal level that won't contribute to the reduction of the battery's life (i.e., not overcharged).

FIG. 4B illustrates an example method of operation in the flow chart 450. Referring to FIG. 4B, the method include identifying an event entry stored in an event application at operation 452, estimating a time duration associated with the event at operation 454 and calculating an amount of battery charge required to satisfy the event being conducted on an electronic device at operation 456. The method may also include charging a battery of the electronic device to a charge level corresponding to the calculated amount of battery charge at operation 458.

FIG. 4C illustrates an example method of operation in the flow chart 470. Referring to FIG. 4C, the method may include identifying an electronic device use event comprising at least one of an amount of time and an amount of battery charge used to perform the use event at operation 472, storing the electronic device use event in memory at operation 474 and retrieving the electronic device use event from memory responsive to a battery charge management operation at operation 476. The method may also include applying the electronic device use event to the battery charge management operation at operation 478.

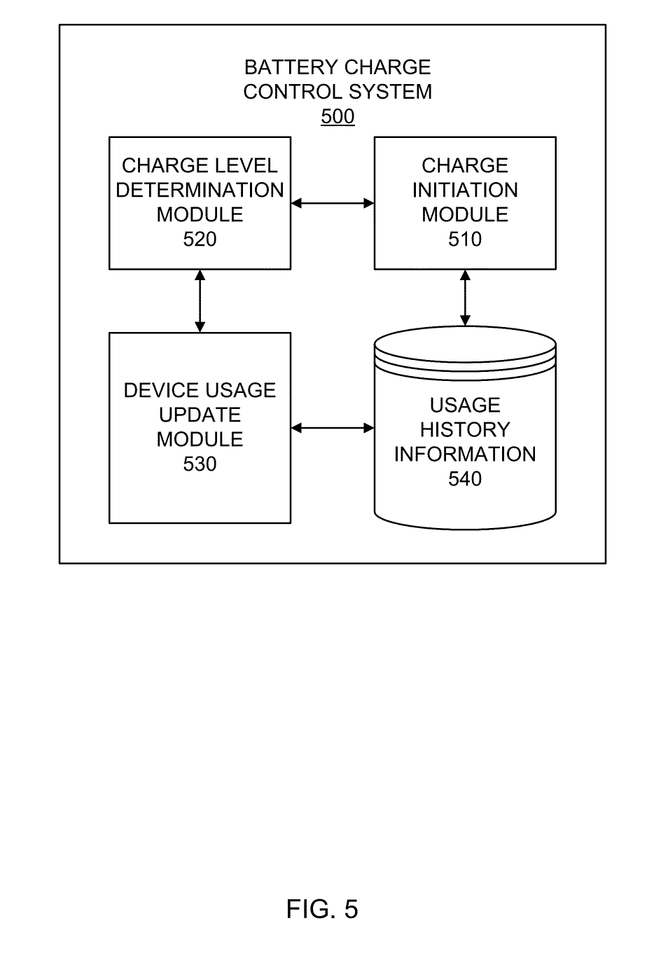

FIG. 5 illustrates an example system configuration configured to perform operations related to the example embodiments. Referring to FIG. 5, the battery charge control system 500 includes a charge initiation module configured to identify an electronic device use event that includes an amount of time or an amount of battery charge used to perform the use event. For example, a presentation, a call, a GPS usage activity, an application usage, etc., is identified as a use event. The use event information is identified by its event type, battery usage and time usage and such information is stored in memory via the usage history information 540. A charge level determination module may retrieve the electronic device use event from memory responsive to a battery charge management operation being initiated (i.e. a charge request or initiation signal). The electronic device use event may be applied to the battery charge management operation via the device usage update module 530.

The electronic device use event may be a time use duration performed on the electronic device or a specific application. The battery of the electronic device may be charged for a predefined amount of time based on a function of the use event information. A predefined amount of time is directly proportional to a use event use time duration. The battery of the electronic device may also be charged until a threshold battery charge level is obtained based on a function of the use event information, such as the amount of time used, the type of application or other charge criteria used to determine how long or how much to charge the battery. Also, the threshold battery charge level may be based on a corresponding category of the application (i.e., GPS, video/audio, data usage requirements, etc.).

Another example embodiment of the present application may include a method that is performed by the system 500 that includes identifying an event entry stored in an event application. Examples of events may include a group presentation in a calendar application which identifies the event as having a particular time frame, a particular application (e.g., MICROSOFT POWERPOINT®, etc.). This information may be identified and an estimated time duration may also be identified or estimated as being associated with the event via the initiation module 510. Next, an amount of battery charge required to satisfy the event being conducted on the electronic device may be calculated via the charge level determination module 520 and the battery of the electronic device may be charged to a charge level corresponding to the calculated amount of battery charge via the update usage module 530.

The event entry may be a calendar entry in a calendar application operated by the electronic device. Further operations may include determining at least one application that will be used during the event and estimating an amount of battery charge required to operate the application during the event. The operations may also include calculating an amount of battery charge required to operate the application during the event based on application type, time usage estimated and other device features which may be invoked during the presentation (i.e., data usage from Internet access, video and audio functions, etc.) which may be battery use intensive. The battery may then be charged to add a charge level that is required for the event. The battery may be charged until the charge level has been satisfied. In order to confirm the amount of charging is accurate, the battery charge level may be monitored during the charging of the battery to ensure the battery is not overcharged. The monitoring may be performed every 30 seconds, 60 seconds, 90 seconds, etc. to ensure the battery charge is not greater than the predefined battery charge level.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

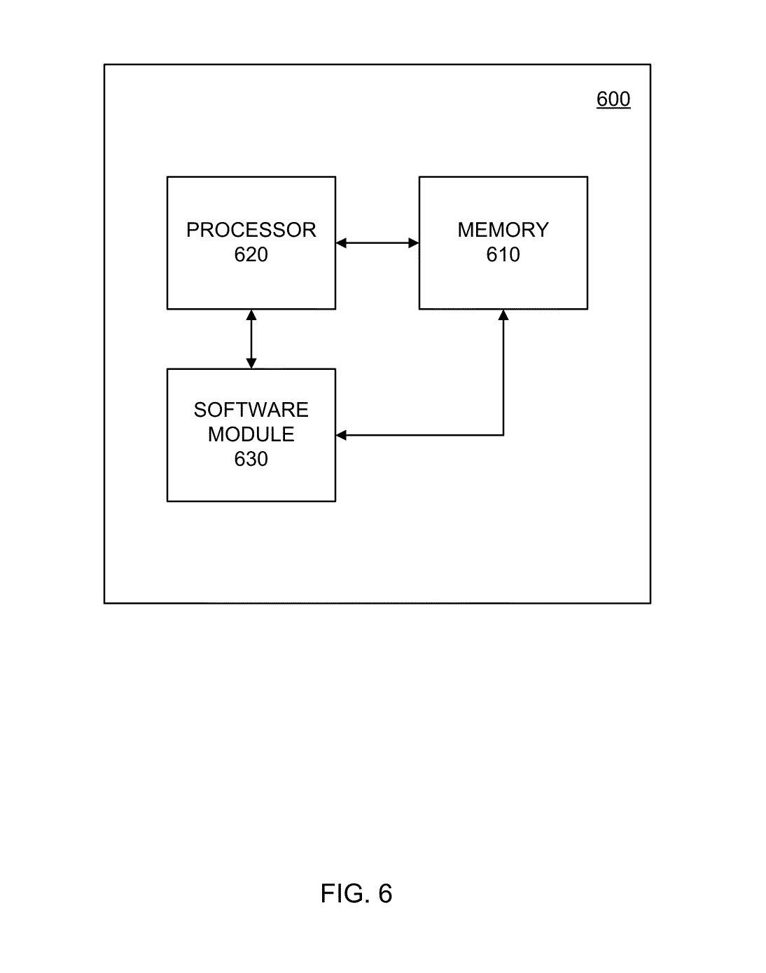

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 6 illustrates an example network element 600, which may represent any of the above-described network components, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system of FIG. 5 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying an event entry stored in an event application;
estimating a time duration associated with the event;
calculating an amount of battery charge required to satisfy the event being conducted on an electronic device; and
charging a battery of the electronic device to a charge level corresponding to the calculated amount of battery charge.

2. The method of claim 1, wherein the event entry is a calendar entry in a calendar application operated by the electronic device.

3. The method of claim 1, further comprising:
determining at least one application that will be used during the event;
estimating an amount of battery charge require to operate the at least one application during the event.

4. The method of claim 3, further comprising:
calculating an amount of battery charge required to operate the at least one application during the event.

5. The method of claim 1, further comprising:
charging the battery to add a charge level that is required for the event; and
stopping the battery charging after the charge level has been satisfied.

6. The method of claim 5, further comprising:
monitoring the battery charge level during the charging of the battery to ensure the battery is not overcharged.

7. The method of claim 6, wherein the monitoring is performed at least one of every 30 seconds, 60 seconds, 90 seconds.

8. An apparatus comprising:
a processor configured to
identify an event entry stored in an event application,
estimate a time duration associated with the event;
calculate an amount of battery charge required to satisfy the event being conducted on an electronic device; and
a battery charging interface configured to charge a battery of the electronic device to a charge level corresponding to the calculated amount of battery charge.

9. The apparatus of claim 8, wherein the event entry is a calendar entry in a calendar application operated by the electronic device.

10. The apparatus of claim 8, wherein the processor is further configured to
determine at least one application that will be used during the event, and
estimate an amount of battery charge require to operate the at least one application during the event.

11. The apparatus of claim 10, wherein the processor is further configured to calculate an amount of battery charge required to operate the at least one application during the event.

12. The apparatus of claim 8, wherein the battery charge interface is further configured to charge the battery to add a charge level that is required for the event, and stop the battery charging after the charge level has been satisfied.

13. The apparatus of claim 12, wherein the processor is further configured to monitor the battery charge level during the charging of the battery to ensure the battery is not overcharged.

14. The apparatus of claim 13, wherein the monitor operation is performed at least one of every 30 seconds, 60 seconds, 90 seconds.

15. A non-transitory computer readable storage medium configured to store instructions that when executed cause a processor to perform:
identifying an event entry stored in an event application;
estimating a time duration associated with the event;
calculating an amount of battery charge required to satisfy the event being conducted on an electronic device; and
charging a battery of the electronic device to a charge level corresponding to the calculated amount of battery charge.

16. The non-transitory computer readable storage medium of claim 15, wherein the event entry is a calendar entry in a calendar application operated by the electronic device.

17. The non-transitory computer readable storage medium of claim 15, wherein the processor is further configured to perform:
determining at least one application that will be used during the event; and
estimating an amount of battery charge require to operate the at least one application during the event.

18. The non-transitory computer readable storage medium of claim 17, further comprising:
calculating an amount of battery charge required to operate the at least one application during the event.

19. The non-transitory computer readable storage medium of claim 15, wherein the processor is further configured to perform:
charging the battery to add a charge level that is required for the event; and
stopping the battery charging after the charge level has been satisfied.

20. The non-transitory computer readable storage medium of claim 19, further comprising:
monitoring the battery charge level during the charging of the battery to ensure the battery is not overcharged, and wherein the monitoring is performed at least one of every 30 seconds, 60 seconds, and 90 seconds.
